(19) United States
(12) Patent Application Publication
(10) Pub. No.: US 2013/0147912 A1
(43) Pub. Date: Jun. 13, 2013

(54) THREE DIMENSIONAL VIDEO AND GRAPHICS PROCESSING

(71) Applicants: Jae Hoon Kim, San Diego, CA (US); David M. Baylon, San Diego, CA (US)

(72) Inventors: Jae Hoon Kim, San Diego, CA (US); David M. Baylon, San Diego, CA (US)

(73) Assignee: GENERAL INSTRUMENT CORPORATION, Horsham, PA (US)

(21) Appl. No.: 13/316,103

(22) Filed: Dec. 9, 2011

(51) Int. Cl. H04N 13/00

(52) U.S. Cl. 348/43; 348/E13.062; 348/E13.068; 348/E13.071

(57) ABSTRACT

A 3D video and graphics processing system may include at least one interface to receive an input video stream. The input video stream may include a 2D, a 3D, or a 2D/3D mixed content stream. A decoder may decode the input video stream. A processor may determine a source format of the input video stream from the decoded input video stream, and determine a target format for an external device to use to display content. The processor may further determine whether the source format matches the target format, if yes, the processor may send the input video stream to the at least one interface, and if no, the processor may modify the input video stream to be in the target format and send the modified input video stream to the at least one interface, for transmitting as an output video stream to the external device.

### BACKGROUND

A set-top box (STB) is a computerized device that processes digital information. A STB is commonly used to receive encoded/compressed digital signals from a signal source (e.g., cable provider's headend) and decodes/decompresses those signals, converting them into signals that a television (TV) connected to the STB can understand and display.

Three dimensional (3D) TVs are becoming popular, and content providers are starting to provide a wide range of 3D content to the customer premises. 3D viewing refers to a technique for creating the illusion of depth in an image by presenting two offset images separately to the left and right eye of the viewer. Typically, a left-eye view and a right-eye view of the content are provided in the signal sent to the STB and the 3D TV. The STB decodes the signal and sends the decoded 3D content to the 3D TV. The 3D TV then displays the 3D content including the left eye view and the right eye view. Glasses worn by the viewer may be used to create the 3D effect, for example, by filtering the displayed views for each eye.

3D content may be delivered to the customer premises in different 3D formats from different content providers. For example, the left-eye view and the right-eye view may be arranged in a top-bottom panel format or a left-right panel format. The 3D TV may convert the 3D content format to a format used by the 3D TV to display the images. In addition, content providers also provide conventional two-dimensional (2D) content to the customer premises. In some instances, 3D content (e.g., a movie) is mixed with 2D content (e.g., a commercial) on the same channel. Also, a viewer may perform a channel change between 2D and 3D channels. In these instances, the 3D TV often has to switch between a 2D mode and a 3D mode depending on the type of content. The switching between the 3D formats performed at the 3D TV and the switching between 2D and 3D modes at the 3D TV may cause delay in displaying the content to the viewer. For example, the mode switching can cause a blank screen to be displayed on the 3D TV while switching is performed, which can be annoying to the viewer. Also, graphics resolution may be reduced due to the format change.

### SUMMARY

As described in detail below, a three dimensional (3D) video and graphics processing system may include at least one interface to receive an input video stream. The input video stream may include a two dimensional (2D) content stream, a 3D content stream, or a 2D and 3D (2D/3D) mixed content stream. A decoder may decode the input video stream. A processor may determine a source format of the input video stream from the decoded input video stream, determine a target format for an external device to use to display content, and determine whether the source format matches the target format. An external device may be a device that is outside of a device including the 3D video and graphics processing system and may be connected through the at least one interface. If the source format matches the target format, the processor may send the input video stream to the at least one interface. If the source format does not match the target format, the processor may modify the input video stream to be in the target format and send the modified input video stream to the at least one interface. The at least one interface may transmit the input video stream or the modified input video stream sent from the processor as an output video stream to the external device.

For the 3D video and graphics processing system described above, for the external device, a channel change may be considered part of the same input video stream. For example, for a channel change that switches between 2D, 3D, 2D/3D mixed content stream, or different format 3D content, the switching may be considered part of the same input stream.

For the system described above, the processor may perform handshake signaling with the external device to determine the target format of the external device. The handshake signaling may be performed, for example, by high-definition multimedia interface (HDMI) handshake signaling.

The external device may be operable to utilize multiple 3D formats to display the output video stream and the processor may instruct the external device through the handshake signaling to maintain its format in the target format. The external device may display the output video stream received from the at least one interface without switching between different 3D modes or without switching between a 2D mode and a 3D mode. The processor may determine the source format from supplementary enhancement information (SEI) in the decoded input video stream. For example, the SEI information may be the information in the header of a H.264 AVC video stream. The processor may be provided in a set-top box (STB) connected to the external device via the at least one interface.

For the system described above, if the external device is a passive 3D TV, and for 3D conversion in the 3D TV, the processor may modify (e.g., deinterleave and arrange) received 2D content to a 3D panel format. For the passive 3D TV, the at least one interface may transmit panel format received 3D content without modification to the 3D TV. If the display is a passive 3D TV, and for no 3D conversion in the 3D TV, the processor may modify (e.g., line interleave) received 3D panel format content to a line interleave format. For the passive 3D TV, the at least one interface may transmit received 2D content without modification to the 3D TV. If the display is an active DLP 3D TV, the at least one interface may transmit received CB 3D content and 2D content without modification to the 3D TV. If the display is an active DLP 3D TV, the processor may modify received 3D panel format or full resolution content to CB format, and the at least one interface may transmit received 2D content without modification to the 3D TV. If the display is an active panel format 3D TV, the processor may downscale and cascade received full resolution 3D content to panel format, and modify (e.g., deinterleave and arrange) received 2D content to panel format. If the display is an active panel format 3D TV, the at least one interface may transmit received 3D panel format content without modification to the 3D TV, and the processor may modify (e.g., deinterleave and arrange) received 2D content to panel format. If the display is an active full resolution 3D TV, the at least one interface may transmit received full resolution 3D content without modification to the 3D TV, and the processor may repeat received 2D content. If the display is an active full resolution 3D TV, the processor may upscale received 3D panel format content to full resolution 3D format, and repeat received 2D content.

For the system described above, the processor may generate graphics based on the target format and overlay the graphics on the output video stream to be transmitted to the external device from the at least one interface. Graphics may include any content to be overlaid on the video stream and may include, for example, pictures, text, etc. The processor may determine an external device mapping. The external device mapping may include a mapping of pixels from the target format to a display format of the external device. The display format may be the format used by the external device to display video signals received in the target format. The processor may overlay the graphics on the output video stream by mapping lines from the graphics to a panel in the target format according to the external device mapping.

As described in detail below, a method for 3D video and graphics processing may include receiving an input video stream. The input video stream may include a 2D content stream, a 3D content stream, or a 2D and 3D (2D/3D) mixed content stream. The method may include decoding the input video stream, determining a source format of the input video stream from the decoded input video stream, determining a target format for an external device to use to display content, and determining, by a processor, whether the source format matches the target format. If the source format matches the target format, the method may include sending the input video stream to at least one interface. If the source format does not match the target format, the method may include modifying the input video stream to be in the target format and sending the modified input video stream to the at least one interface. The at least one interface may transmit the input video stream or the modified input video stream as an output video stream to the external device.

For the method described above, the method may further include performing handshake signaling with the external device to determine the target format of the external device. The external device may be operable to utilize multiple 3D formats to display the output video stream. The method may further include instructing the external device through the handshake signaling to maintain its format in the target format. The method may include displaying at the external device the output video stream received from the at least one interface without switching between different 3D modes or without switching between a 2D mode and a 3D mode. The method may further include determining the source format from SEI in the decoded input video stream. The method may further include providing the processor in a STB connected to the external device via the at least one interface. If the external device is a passive 3D TV, and for 3D conversion in the 3D TV, the method may further include modifying (e.g., deinterleaving and arranging) received 2D content to a 3D panel format. For the passive 3D TV, the method may further include transmitting panel format received 3D content without modification to the 3D TV. If the display is a passive 3D TV, and for no 3D conversion in the 3D TV, the method may further include modifying received 3D panel format content to a line interleave format. For the passive 3D TV, the method may further include transmitting received 2D content without modification to the 3D TV. If the display is an active DLP 3D TV, the method may further include transmitting received CB 3D content and 2D content without modification to the 3D TV. If the display is an active DLP 3D TV, the method may further include modifying received 3D panel format or full resolution content to CB format, and transmitting received 2D content without modification to the 3D TV. If the display is an active panel format 3D TV, the method may further include downscaling and cascading received full resolution 3D content to panel format, and modifying (e.g., deinterleaving and arranging) received 2D content to panel format. If the display is an active panel format 3D TV, the method may further include transmitting received 3D panel format content without modification to the 3D TV, and modifying (e.g., deinterleaving and arranging) received 2D content to panel format. If the display is an active full resolution 3D TV, the method may further include transmitting received full resolution 3D content without modification to the 3D TV, and repeating received 2D content. If the display is an active full resolution 3D TV, the method may further include upscaling received 3D panel format content to full resolution 3D format, and repeating received 2D content. The method may further include generating graphics based on the target format and overlaying the graphics on the output video stream to be transmitted to the external device from the at least one interface. The method may further include determining an external device mapping. The external device mapping may include a mapping of pixels from the target format to a display format of the external device. The method may further include overlaying the graphics on the output video stream by mapping lines from the graphics to a panel in the target format according to the external device mapping.

As described in further detail below, a non-transitory computer readable medium is provided. The non-transitory computer readable medium stores computer readable instructions when executed by a computer system perform a method for 3D video and graphics processing. The method may include receiving an input video stream. The input video stream may include a 2D content stream, a 3D content stream, or a 2D and 3D (2D/3D) mixed content stream. The method may include decoding the input video stream, determining a source format of the input video stream from the decoded input video stream, determining a target format for an external device to use to display content, and determining, by a processor, whether the source format matches the target format. If the source format matches the target format, the method may include sending the input video stream to at least one interface. If the source format does not match the target format, the method may include modifying the input video stream to be in the target format and sending the modified input video stream to the at least one interface. The at least one interface may transmit the input video stream or the modified input video stream as an output video stream to the external device.

### BRIEF DESCRIPTION OF THE DRAWINGS

Features of the present disclosure will become apparent to those skilled in the art from the following description with reference to the figures, in which:

FIG. 1 is a simplified block diagram of a 3D video and graphics processing system, according to an embodiment;

FIG. 2 is a block diagram of the 3D video and graphics processing system, illustrating processing of a 2D/3D mixed content stream for a passive 3D TV system, according to an embodiment;

FIG. 3 is a block diagram of the 3D video and graphics processing system, illustrating processing of a 2D/3D mixed content stream for an active DLP 3D TV system, according to an embodiment;

FIG. 4 is a block diagram of the 3D video and graphics processing system, illustrating processing of a 2D/3D mixed content stream for an active panel format 3D TV system, according to an embodiment;

FIG. 5 is a block diagram of the 3D video and graphics processing system, illustrating processing of a 2D/3D mixed content stream for an active full resolution 3D TV system, according to an embodiment;

FIG. 6 is a block diagram illustrating graphics generation according to input video format, according to an embodiment;

FIG. 7 is a block diagram illustrating graphics generation according to 3D TV format, according to an embodiment;

FIG. 8 is an example of deinterleaving of a caption in top-bottom 3D format to increase perceived resolution in 3D, according to an embodiment;

FIG. 9 is an example of graphics mappings into a 3D panel format, according to an embodiment;

FIG. 10 is a method for 3D video and graphics processing, according to an embodiment; and

FIG. 11 illustrates a computer system that may be used for the system and related method, according to an embodiment.

### DETAILED DESCRIPTION

For simplicity and illustrative purposes, the present disclosure is described by referring mainly to examples thereof. In the following description, numerous specific details are set forth in order to provide a thorough understanding of the present disclosure. It is readily apparent however, that the present disclosure may be practiced without limitation to these specific details. In other instances, some methods and structures have not been described in detail so as not to unnecessarily obscure the present disclosure. Furthermore, different examples are described below. The examples may be used or performed together in different combinations. As used herein, the term “includes” means includes but not limited to the term “including”. The term “based on” means based at least in part on.

### 1. Overview

According to an embodiment, a 3D video and graphics processing system converts 2D content to 3D content and also formats 3D content to the 3D format used by the 3D TV. The 3D video and graphics processing system may be provided inside a STB or may be a STB. The system determines a source format of a 2D, 3D, or 2D/3D mixed content input video stream and also determines a target format for an external device, such as a 3D TV to use to display content. The system outputs an output video stream which provides converted 2D-to-3D content to the 3D TV in the 3D format used by the 3D TV (referred to as the display format). Then, the 3D TV may continuously operate in 3D mode to display the content, regardless of whether the content was originally 2D content or in a 3D source format different than the display format used by the 3D TV for displaying the 3D content. Accordingly, delay at the 3D TV for format conversion is minimized and no user input is needed to switch between 2D and 3D modes at the 3D TV. Source format is used to describe the format of the signal received by the 3D video and graphics processing system. Examples of source formats include 2D, 3D, different 3D formats such as top-bottom panel format, left-right panel format, checkerboard, etc., or 2D/3D mixed content. 2D and 3D modes are modes of operation of the display, which may be a 3D TV or 3D monitor. In 2D mode, the display displays content in 2D and similarly in 3D mode the display displays the content in 3D.

Also, display format information may be used by the STB to overlay graphics using the display format of the 3D TV instead of the source format, thus providing improved graphics quality. Additionally, different source formats may be converted to one target format so that, for example, there is no delay in HDMI switching between 2D and 3D or among different 3D source formats. Together with information about the source format, 2D content such as, for example, commercials, may be correctly mapped into the target format so that the 2D content can be properly viewed with or without 3D viewing glasses.

As described in detail below, with format conversion supported inside the STB, graphics quality can also be improved, and graphics may be properly shown in 3D using the 3D TV format. Also, backward compatibility is provided for existing signaling standard (e.g., HDMI v1.3 or less, component, etc.) and there is no delay in switching between 2D and 3D or between one 3D format to another 3D format. Moreover, the 3D STB provides for handling of mixed 2D and 3D content delivery and channel switching between 2D and 3D without modification to an existing headend system.

### 2. System

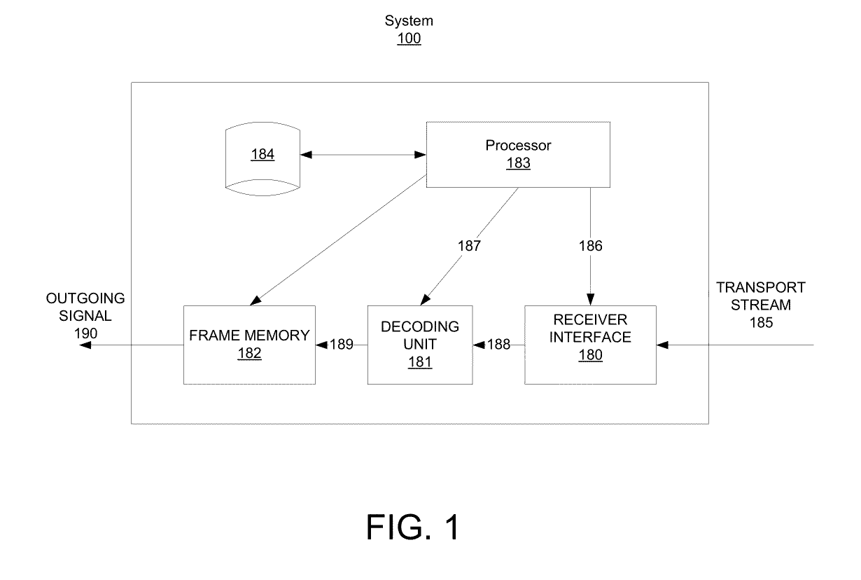

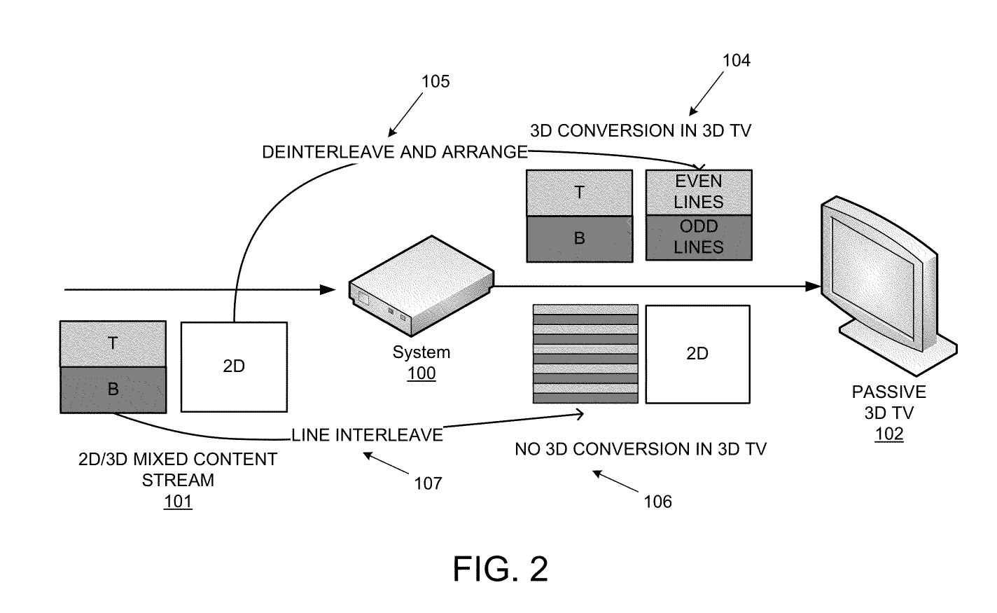

As described herein with reference to FIGS. 1-11, a 3D video and graphics processing system 100 is described and provides for processing of 2D/3D mixed content. Referring to FIG. 1, there is shown a simplified block diagram of the system 100, shown as a decoding apparatus, such as a STB. Alternatively, the system 100 may be provided in a STB. The system 100 is operable to implement 3D video and graphics processing, discussed below with reference to FIGS. 2-11.

The system 100 may include a receiver interface 180, a decoding unit 181, a frame memory 182, a processor 183 and a storage device 184. The system 100 may receive a transport stream 185 (i.e., input video stream generally, shown, for example, as 2D/3D mixed content stream in FIGS. 2-5) with compressed video data. The transport stream 185 is not limited to any specific video compression standard. The processor 183 of the system 100 may control the amount of data to be transmitted on the basis of the capacity of the receiver interface 180 and may include other parameters such as the amount of data per a unit of time. The processor 183 may control the decoding unit 181, to prevent the occurrence of a failure of a received signal decoding operation of the system 100. The processor 183 may include hardware performing the functions of the STB.

The transport stream 185 (e.g., 2D/3D mixed content stream of FIGS. 2-5) may be supplied from, for example, a headend facility. The transport stream 185 may include stereoscopic video. The stereoscopic video may include pictures and/or frames which are decoded at the system 100. The receiver interface 180 of the system 100 may temporarily store the encoded data received from the headend facility via the transport stream 185. The system 100 may count the number of coded units of the received data, and output a picture or frame number signal 186 which is applied through the processor 183. The processor 183 may supervise the counted number of frames at a predetermined interval, for instance, each time the decoding unit 181 completes the decoding operation.

When the picture/frame number signal 186 indicates the receiver interface 180 is at a predetermined capacity, the processor 183 may output a decoding start signal 187 to the decoding unit 181. The processor 183 may also control operation of the frame memory 182. When the frame number signal 186 indicates the receiver interface 180 is at less than a predetermined capacity, the processor 183 may wait for the occurrence of the situation in which the counted number of pictures/frames becomes equivalent to the predetermined amount. When the picture/frame number signal 186 indicates the receiver interface 180 is at the predetermined capacity, the processor 183 may output the decoding start signal 187. The encoded units may be decoded, for example, in a monotonic order (i.e., increasing or decreasing) based on a presentation time stamp (PTS) in a header of the encoded units. In response to the decoding start signal 187, the decoding unit 181 may decode data amounting to one picture/frame from the receiver interface 180, and outputs the data. The decoding unit 181 writes a decoded signal 189 into the frame memory 182. The decoding unit 181 decodes the A/V stream 188 to form the decoded A/V stream 189 which may include a 3D video stream. The frame memory 182 has a first area into which the decoded signal is written, and a second area used for reading out the decoded data and outputting it to a display for a 3D TV or the like. The frame memory 182 may forward an outgoing signal 190 (i.e., output video stream) to a display unit as described herein with reference to FIGS. 2-10. Similar to the receiver interface 180, another interface may be provided at the frame memory 182 for the outgoing signal 190.

Disclosed herein are a method and a system for 3D video and graphics processing. It is apparent to those of ordinary skill in the art that the diagram of FIG. 1 represents a generalized illustration and that other components may be added or existing components may be removed, modified or rearranged without departing from the scope of the system 100.

The system 100 is depicted as including, as subunits 180-184, the receiver interface 180, the decoding unit 181, the frame memory 182, the processor 183 and the storage device 184. The subunits 180-184 may comprise modules and other components that may include machine readable instructions, hardware or a combination of machine readable instructions and hardware. Thus, in one example, the subunits 180-184 may comprise circuit components. In another example, the subunits 180-184 may comprise code stored on a computer readable storage medium, which the processor 183 is to execute. As such, in one example, the system 100 comprises a hardware device, such as, a computer, a server, a circuit, etc. In another example, the system 100 comprises a computer readable storage medium upon which machine readable instructions for performing the functions of the subunits 180-184 are stored. The various functions that the system 100 performs are discussed in greater detail below.

Referring to FIGS. 2-5, processing of a 2D/3D mixed content stream is discussed for two different types of 3D TVs, namely, a passive polarization 3D TV system and an active shutter glass 3D TV system.

Specifically, referring to FIG. 2, a block diagram illustrating processing of a 2D/3D mixed content stream 101 for a passive 3D TV 102, according to an embodiment, is shown. For 2D content mixed with 3D, it is assumed that the source format of the delivered content, such as, for example, 2D, 3D side-by-side (SS), 3D top-bottom (TB), etc., and the target format of the 3D TV is known or otherwise determined by system 100. Generally, the passive 3D TV 102 of FIG. 2 may use line (horizontally/vertically) interleaved filters corresponding to left and right eye views. Any 3D input to the 3D TV 102 may be rearranged to horizontally/vertically interleaved lines before being watched in 3D. For example, 3D panel inputs (e.g., SS, TB and checkerboard (CB)) may be converted by the passive 3D TV 102 to a line interleaved signal.

In order to handle 2D content in a 3D stream (e.g., the 2D/3D mixed content stream 101), the cases of 3D conversion (panel to line interleaving) in 3D TV at 104 and no 3D conversion in 3D TV at 106 are shown in FIG. 2. If the passive 3D TV 102 receives a panel input and performs line-interleaving, 2D content should be in the same format as the 3D content. FIG. 2 illustrates how 2D content may be reformatted (i.e., modified) by the system 100 before being delivered to the 3D TV 102. For example, as shown at 104 for 3D conversion in 3D TV, when 3D panel format is TB, for 2D content, by deinterleaving and arranging even/odd lines at 105 into a top and bottom panel, 2D content may be watched without changing the mode and/or removing 3D viewing glasses. Alternatively, as shown at 106, if 3D conversion is not performed in the passive 3D TV 102, 3D content in panel format (e.g., TB) may be line interleaved at 107 and 2D content may be passed (i.e., transmitted) through the system 100 as shown in FIG. 2. The passive 3D TV 102 may display the video input as delivered through the filter in the TV screen, thus stereoscopic 3D (S3D) is still perceived. Further, 2D content may be watched without changing the mode of the passive 3D TV 102 and/or removing 3D viewing glasses. The conversion operations (i.e., modifications) may be performed inside the system 100 or any other device between a decoder and the passive 3D TV 102.

Thus as shown in FIG. 2, with the 2D/3D mixed content stream 101 including, for example, a TB 3D format and 2D content, if the 2D/3D mixed content stream 101 is sent directly to the passive 3D TV 102, for the TB 3D format, the 3D TV 102 would convert the TB 3D format to line interleaved. For the 2D format, the passive 3D TV 102 would have to switch from 3D to 2D to display 2D. As discussed above, this type of switching can cause delay during format conversion. Instead, as discussed above, as a first option, for the 2D content, the system 100 may perform deinterleaving and arranging of even/odd lines at 105 into top/bottom panel format, and 2D content may be watched without changing the mode of the passive 3D TV 102 and/or removing 3D viewing glasses. Further, as a second option, with the system 100, the 2D/3D mixed content stream 101 may be processed in the system 100 as shown at 106, where the TB 3D content in panel format (e.g., TB) may be line interleaved at 107 and 2D content may be passed through to the passive 3D TV 102 without conversion.

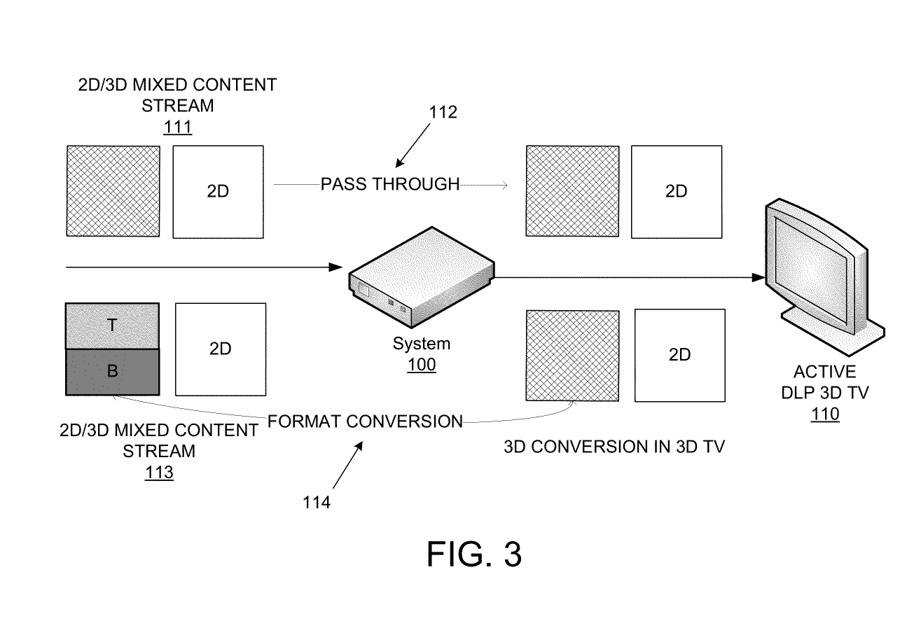

FIGS. 3-5 are block diagrams illustrating the 3D video and graphics processing system 100 for processing of 2D/3D mixed content for active 3D TV systems.

Referring to FIG. 3, an active digital light processing (DLP) 3D TV 110 supporting CB format is illustrated. For 3D video in CB, the DLP 3D TV 110 shows each quincunx sampled field alternatively to each eye (left/right) of a viewer. For a 2D/3D mixed content stream 111, if 2D content is arriving after 3D video, it can be passed (i.e., transmitted) through the system 100 as shown at 112 without any conversion. The DLP 3D TV 110 may treat 2D content as 3D and show each field alternatively to a viewer's eye. Although half pixels of 2D content would be shown at each time instance, viewers do not need to change the mode of the DLP 3D TV 110 to 2D. Thus for the 2D/3D mixed content stream 111 including the 3D content in CB format, the signal may be passed (i.e., transmitted) through the system 100 without any conversion. However, if a 2D/3D mixed content stream 113 is in TB format, the 3D content may be converted (i.e., modified) by the system 100 to CB format as shown at 114. Viewers may watch 2D content with 3D viewing glasses on or off with the DLP 3D TV 110 set to 3D mode. In either case of the type of signal 111 or 113, the system 100 may respectively allow a signal to pass through or perform the necessary format conversion for the active DLP 3D TV 110.

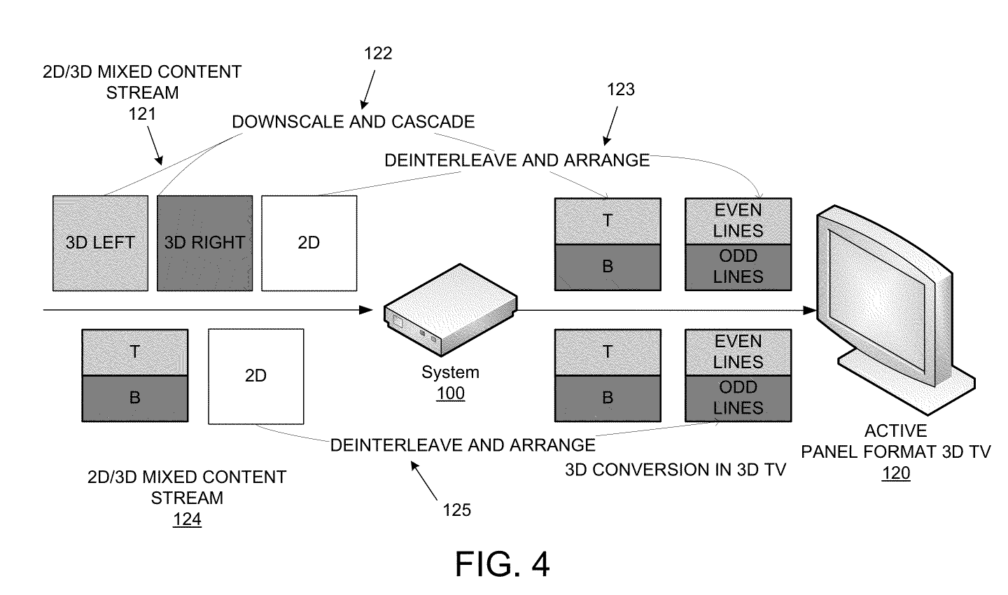

Referring to FIG. 4, an active panel format 3D TV 120 receiving a 3D input in panel format is illustrated. Assuming 3D mode is on for the 3D TV 120, any 3D input may be converted to the 3D format accepted by the 3D TV 120. For a 2D video, the video may also be converted into the 3D format as described in detail in co-pending patent application Ser. No. 13/011,549, filed Jan. 21, 2011, titled “3D Video Graphics Overlay”, the disclosure of which is incorporated herein by reference. As shown in FIG. 4, for the full resolution 2D/3D mixed content stream 121, the 3D left eye signal and 3D right eye signal may be downscaled and cascaded by the system 100 to a TB format at 122. The 2D component of the stream 121 may be deinterleaved first and arranged at 123 into TB, which is assumed to be 3D input format to the 3D TV 120. Alternatively, for the 2D/3D mixed content stream 124, the 3D TB signal may be passed (i.e., transmitted) through the system 100 without conversion. The 2D component of the stream 124 may be deinterleaved first and arranged at 125 into TB.

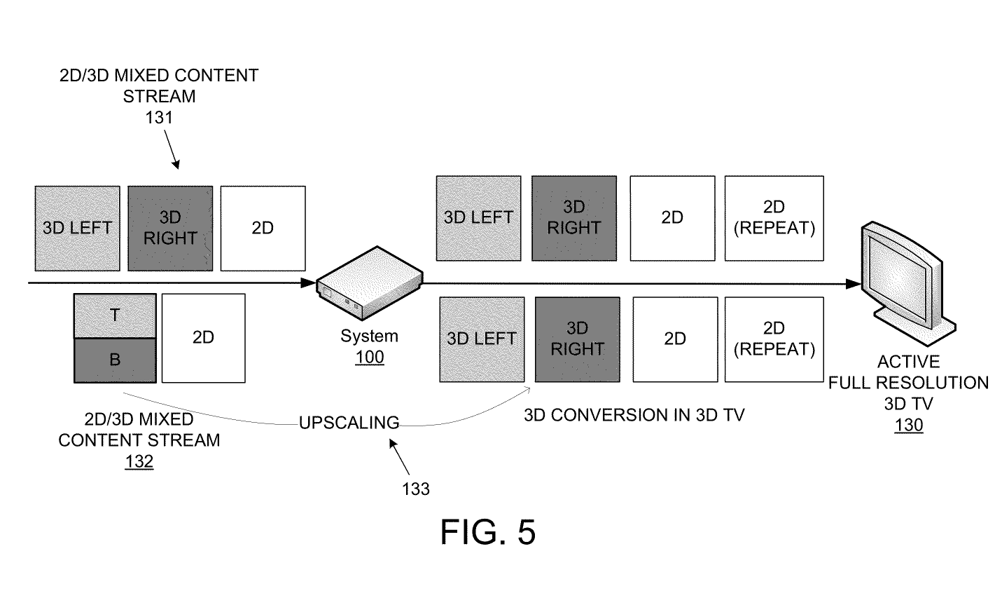

Referring to FIG. 5, an active full resolution 3D TV 130 which supports two full resolution views for each of a viewer's eye is illustrated. For S3D generally, left/right views may be delivered to the 3D TV 130 to be shown alternatively in synchronization with 3D active glasses. As shown in FIG. 5, when 2D content arrives, every 2D picture is repeated so that both eyes can watch the same picture. The receiver or the system 100 may improve 2D video quality by generating a motion compensated picture, as opposed to repeating the same picture. Similar to the DLP 3D TV 110, for 2D content, viewers do not need to change the mode to 2D and can continue to wear 3D viewing glasses or take the glasses off if desired.

Thus as shown in FIG. 5, for the full resolution 2D/3D mixed content stream 131, the 3D left eye signal and 3D right eye signal may be passed (i.e., transmitted) through the system 100 without conversion. For the 2D component of the stream 131, the frequency is doubled by the system 100 for proper display by the 3D TV 130. Thus the 2D component of the stream 131 is repeated such that the first 2D component is shown at time frame ‘0’ and the second 2D repeated component is shown at time frame ‘1’. In this regard, time frame ‘0’ may represent a viewer's left eye and time frame ‘1’ may represent a viewer's right eye. Alternatively, for the 2D/3D mixed content stream 132, the 3D TB component may be upscaled at 133 by the system 100 to 3D left eye and 3D right eye. For the 2D component of the stream 132, the frequency is likewise doubled by the system 100 for proper display by the 3D TV 130, in a similar manner as discussed above for the stream 131.

For the 3D TV systems of FIGS. 2-5, an engine (e.g., the processor 183 of FIG. 1) inside the system 100 may perform format conversion. The converted format may then be used to handle the 2D/3D mixed content and for providing a convenient 3D viewing experience. By knowing which input format and which format a 3D TV uses, the input video may be converted by the system 100 correctly so that when the input to the TV (or output from STB) is converted to the format the TV accepts, the content may be viewed as intended. Moreover, as shown in FIG. 2, it is assumed that in order to handle 2D content in a 3D stream (e.g., the 2D/3D mixed content stream 101), the cases of 3D conversion in 3D TV at 104 and no 3D conversion in 3D TV at 106 are shown. For FIG. 2, the options of 3D conversion in 3D TV or no 3D conversion in 3D TV are based on the characteristics of filters attached to the passive 3D TV 102. For FIGS. 3-5, the 3D conversion is turned on in the 3D TVs (e.g., 3D TVs 110, 120, 130) such that regardless of the 3D or 2D content, the 3D TV performs 3D conversion to eliminate any delay in performing conversion from 2D to 3D or vise versa, which is now performed by the system 100. The conversion by the system 100 also provides viewers with the option to keep 3D viewing glasses on or remove the glasses at the viewer's discretion regardless of whether a 3D TV is displaying 3D and/or 2D content.

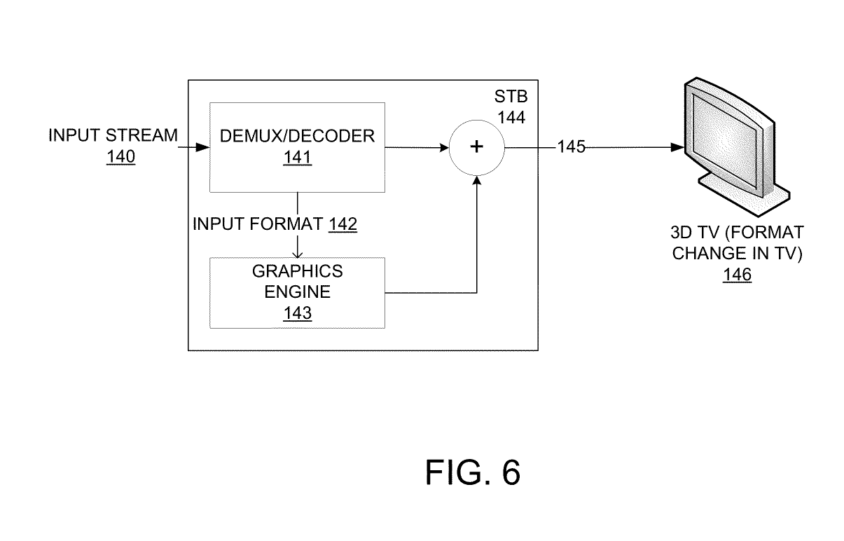

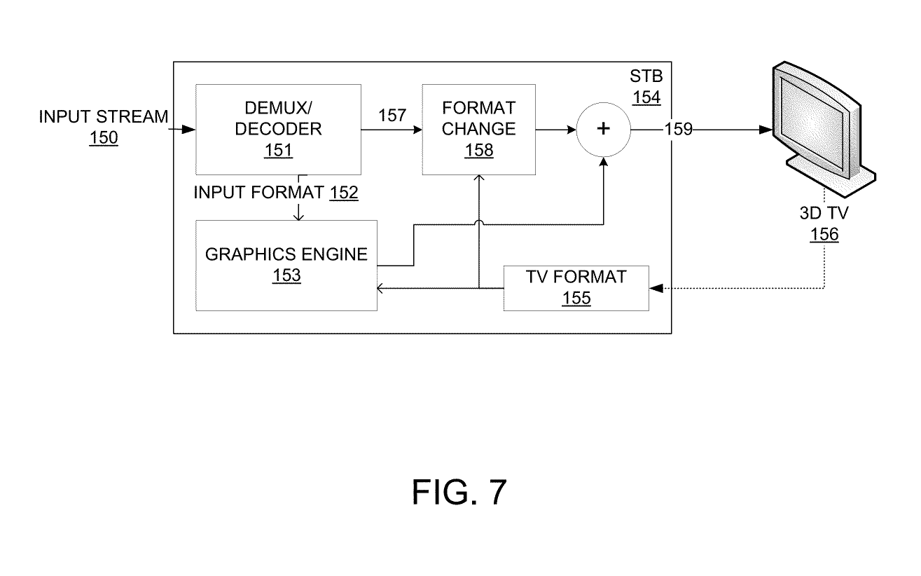

Referring next to FIGS. 6 and 7, graphics generation according to input video and 3D TV format is respectively illustrated.

Graphics including on-screen display (OSD) and caption may be modified according to a 3D system. As described in detail in co-pending patent application Ser. No. 13/011,549, modification of graphics into 3D format corresponding to 2D/3D input video signal as shown in FIG. 6 is described. For example, referring to FIG. 6, after decoding an input stream 140 by demux/decoder 141, the input video format of the video at 142 may be signaled to a graphics engine 143 in the STB 144. The STB 144 may be the system 100, but is described as a separate system for facilitating the description thereof. The graphics engine may create graphics on top of the decoded video stream. The generated graphics may be overlaid on video signal and transmitted at 145 to a 3D TV 146. At the 3D TV 146, the content of the input signal may be appropriately displayed, with the 3D TV 146 performing appropriate conversions based, for example, on the 3D format. This conversion at the 3D TV can result in additional loss in quality of the graphics.

For example, there may be cases where graphics are perceived worse than intended for 3D. For example, an input 3D video signal may be 1080 interlaced SS format and a 3D passive TV renders an input by horizontal line interleaving. In this case, graphics may be generated as the same input format—1080i SS, overlaid on top of video plane and fed to TV. When converted in TV for display, the SS signal may be up-scaled horizontally and down-sampled vertically resulting in the loss of resolution. This may occur when the input video format is different to the TV format.

Thus, instead of overlaying graphics into video according to the input format and then changing them to 3D TV format, first, converting video input to the 3D TV format then inserting graphics in the TV format prevents the loss of resolution caused by the format change. Referring to FIG. 7, the 3D TV format signaled to STB may be used to change video format and generate graphics which are overlaid on the video signal. Thus as shown in FIG. 7, after decoding an input stream 150 by demux/decoder 151, the input video format at 152 may be signaled to a graphics engine 153 in the STB 154. The 3D TV format 155 may be automatically signaled by the 3D TV 156 or set by a user. Based on the 3D TV format 155 and the decoded input stream 157, the format of the decoded video may be conformed to the 3D TV format at 158. Further, based on the input video format at 152 and the 3D TV format at 155, the generated graphics may be overlaid on the video signal and transmitted at 159 to the 3D TV 156. Thus any format conversion is performed by the STB 154 such that no resolution is lost at the 3D TV 156.

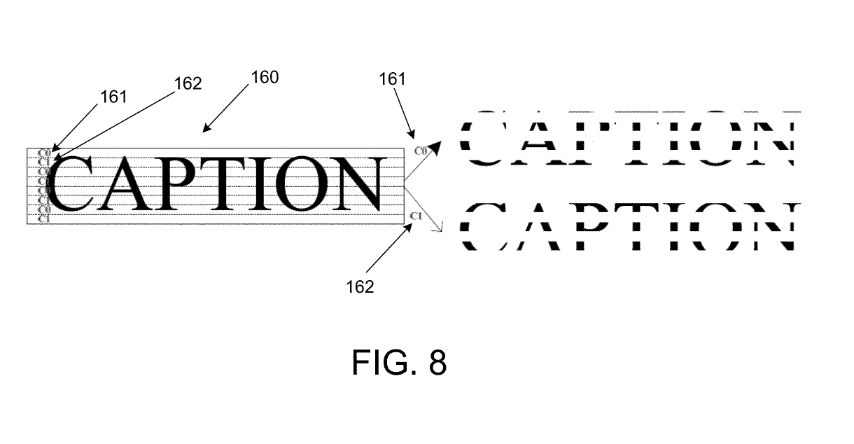

Referring next to FIG. 8, an example of deinterleaving of a caption in top-bottom 3D format to increase perceived resolution in 3D, according to an embodiment, is described.

As described in detail in co-pending patent application Ser. No. 13/011,549, in order to deliver 3D depth in 2D graphics overlay, resized graphics may be placed in two views respectively with disparity. An example of a method for scaling down graphics includes dropping every other line in 2D graphics and repeating the process in each view with the disparity resulting in quality degradation. Noting that the two graphics displaced would be fused in a viewer's brain for 3D perception, a filter may improve the quality after fusion. For example, as shown in FIG. 8, original graphics may be deinterleaved horizontally or vertically according to the 3D panel format and each field may be placed in the proper panel. Referring to FIG. 8, an example of this deinterleaving of the word “CAPTION” at 160 is shown for top-bottom format. The C0 and C1 fields respectively at 161, 162 may be deinterleaved and separated as shown. Scaled-down captions may be placed in the top and bottom panel respectively. When converted into 3D mode, the perceived resolution of graphics after fusion is improved with respect to repeated captions in both top and bottom planes.

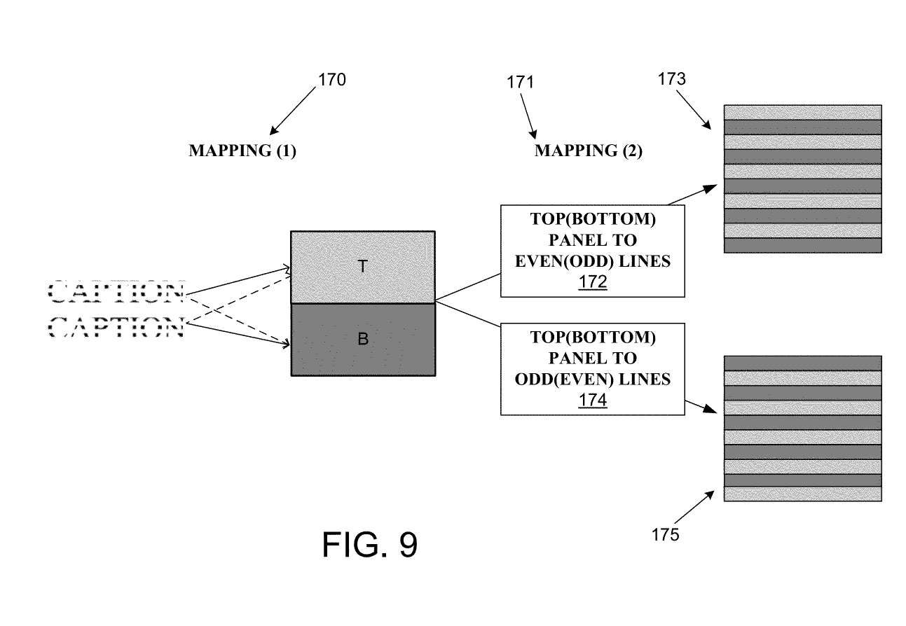

Referring next to FIG. 9, an example of graphics mappings into the 3D panel format, according to an embodiment, is described.

Another aspect considered is the polarity in mapping 3D graphics into the 3D panel format. For example, assuming that TB format is used for 3D TV with horizontal polarization, FIG. 9 illustrates two flexible mappings—mapping (1) at 170 from graphics to TB format and mapping (2) at 171 from TB format to horizontal lines with polarization filters. Mapping (2), which is performed by 3D TV should be known to STB so that mapping (1) can be properly performed. If top (bottom) panel is mapped to the even (odd) lines in the 3D TV screen as shown at 172, even (odd) lines of deinterleaved graphics/caption at 173 may be mapped to the top (bottom) panel. Similarly, if top (bottom) panel is mapped to the odd (even) lines in the 3D TV screen as shown at 174, odd (even) lines of deinterleaved graphics/caption at 175 may be mapped to the top (bottom) panel.

Based on the foregoing, by providing format conversion inside the system 100, 2D and 3D mixed content may be properly displayed without changing between 2D/3D mode in a 3D TV or taking on/off 3D viewing glasses. Graphics quality is also improved, and graphics may be properly shown in 3D using the 3D TV format.

For the 3D video and graphics processing system 100 described herein, or any accessory box, receiver, dvd/blu-ray player, etc., user convenience is provided by eliminating the need to convert 2D/3D mode, or to remove/replace 3D viewing glasses. Backward compatibility is provided to existing signaling standards (e.g., HDMI v1.3 or less, component, etc.) and there is no delay in switching between 2D and 3D or between one 3D format to another 3D format. The system 100 also provides for improved resolution and quality in graphics. Yet further, the system 100 provides for handling of 2D and 3D mixed content delivery and channel switching between 2D and 3D without modification to a conventional head-end system. Moreover, although aspects related to 2D/3D formats are described above with reference to the system 100, the aspects may be implemented in any unit between the decoder and the 3D TV display.

### 3. Method

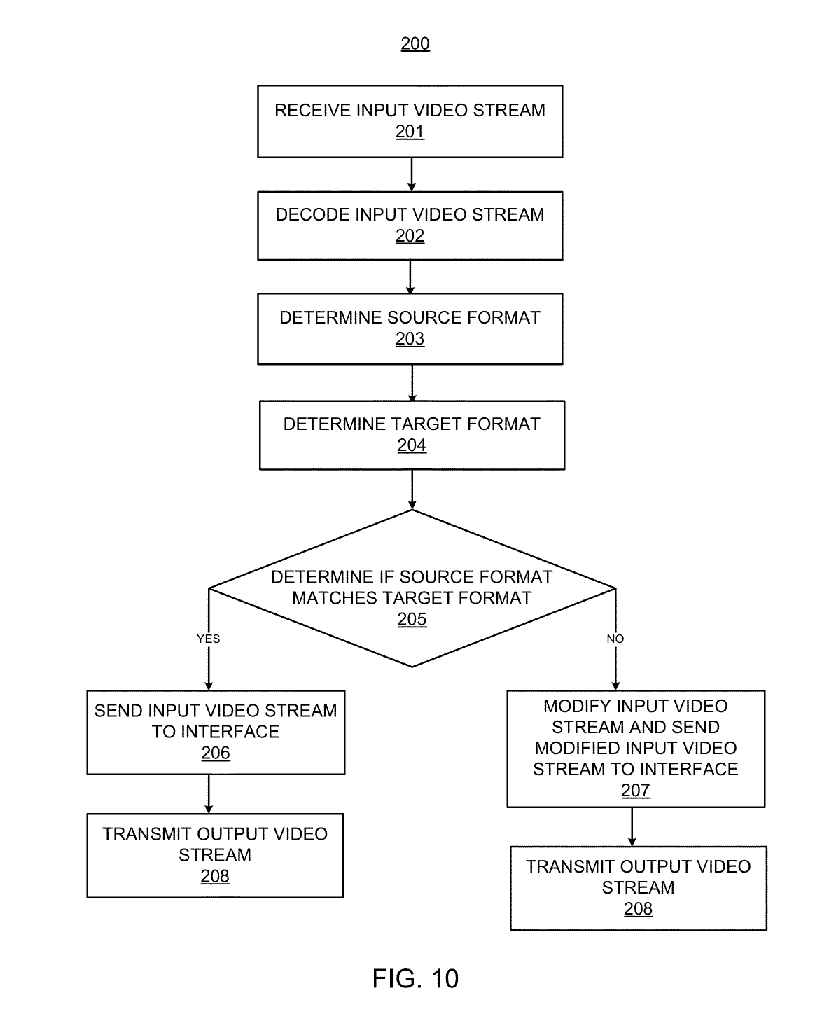

FIG. 10 illustrates a method 200 for 3D video and graphics processing, according to an embodiment. The method 200 may be implemented on the 3D video and graphics processing system 100 described above with reference to FIGS. 1-9 by way of example and not limitation. The method 200 may be practiced in other systems.

For the method 200, referring to FIGS. 1-5 and 10, at block 201, the method may include receiving an input video stream (e.g., streams 101, 113, 124 and 132 of FIGS. 2-5). The input video stream may include a 2D content stream, a 3D content stream, or a 2D and 3D (2D/3D) mixed content stream.

At block 202, the method may include decoding the input video stream.

At block 203, the method may include determining a source format of the input video stream from the decoded input video stream.

At block 204, the method may include determining a target format for an external device (e.g., 3D TVs 102, 110, 120 and 130 of FIGS. 2-5) to use to display content.

At block 205, the method may include determining whether the source format matches the target format.

At block 206, if the source format matches the target format, the method may include sending the input video stream to at least one interface.

At block 207, if the source format does not match the target format, the method may include modifying the input video stream to be in the target format and sending the modified input video stream to the at least one interface.

For blocks 206 and 207, for example, referring to FIGS. 2 and 10, if the external device is the passive 3D TV 102, and for 3D conversion in the 3D TV at 104, the method may further include modifying (e.g., deinterleaving and arranging) received 2D content to a 3D panel format, and transmitting panel format received 3D content without modification to the 3D TV. Still referring to FIGS. 2 and 10, if the display is the passive 3D TV 102, and for no 3D conversion in the 3D TV at 106, the method may further include modifying received 3D panel format content, for example, to a line interleave format, and transmitting received 2D content without modification to the 3D TV. Referring to FIGS. 3 and 10, if the display is the active DLP 3D TV 110, the method may further include transmitting received CB 3D content and 2D content without modification at 112, or alternatively, at 114, modifying received 3D panel format or full resolution content to CB format, and transmitting received 2D content without modification to the 3D TV. Referring to FIGS. 4 and 10, if the display is the active panel format 3D TV 120, the method may further include downscaling and cascading received full resolution 3D content to panel format at 122, and modifying (e.g., deinterleaving and arranging) received 2D content to panel format at 123, or alternatively, transmitting received 3D panel format content without modification to the 3D TV, and modifying (e.g., deinterleaving and arranging) received 2D content to panel format at 125. Referring to FIGS. 5 and 10, if the display is the active full resolution 3D TV 130, the method may further include transmitting received full resolution 3D content without modification to the 3D TV, and repeating received 2D content, or alternatively, upscaling received 3D panel format content to full resolution 3D format at 133, and repeating received 2D content.

At block 208, the method may include transmitting the input video stream or the modified input video stream as an output video stream to the external device.

As described above with reference to FIGS. 7-9, the method may further include generating graphics based on the target format and overlaying the graphics on the output video stream to be transmitted to the external device from the at least one interface. The method may further include determining an external device mapping. The external device mapping may include a mapping of pixels from the target format to a display format of the external device. The method may further include overlaying the graphics on the output video stream by mapping lines from the graphics to a panel in the target format according to the external device mapping.

### 4. Computer Readable Medium

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as programs comprised of program instructions in source code, object code, executable code or other formats. Any of the above may be embodied on a computer readable storage medium, which include storage devices.

An example of a computer readable storage media includes a conventional computer system RAM (random access memory), ROM (read only memory), EPROM (erasable, programmable ROM), EEPROM (electrically erasable, programmable ROM), hard drives, and flash memory. Concrete examples of the foregoing include distribution of the programs on a CD ROM or via Internet download. It is therefore to be understood that any electronic device capable of executing the above-described functions may perform those functions enumerated above.

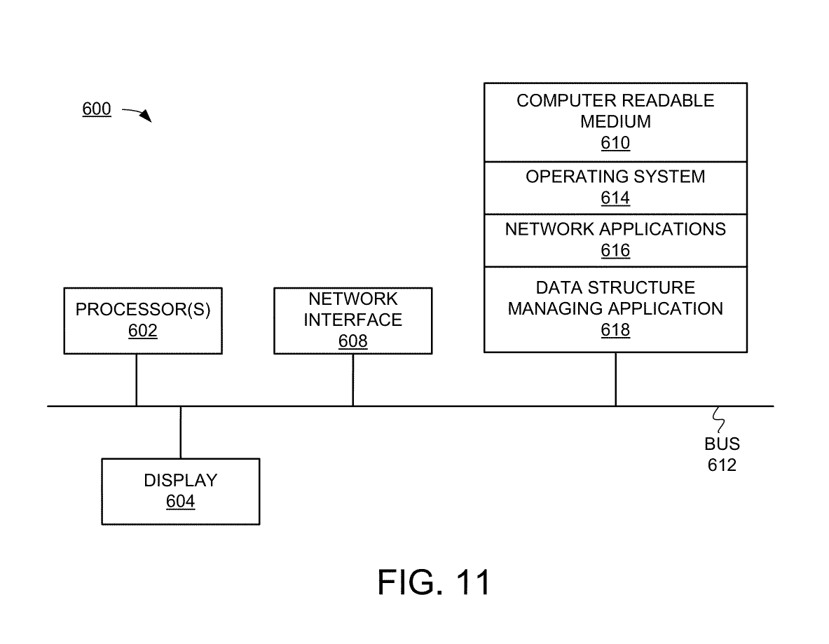

Turning now to FIG. 11, there is shown a computing device 600, which may be employed as a platform for implementing or executing the method 200 depicted in FIG. 10, or code associated with the method. It is understood that the illustration of the computing device 600 is a generalized illustration and that the computing device 600 may include additional components and that some of the components described may be removed and/or modified without departing from a scope of the computing device 600.

The device 600 includes a processor 602, such as a central processing unit; a display device 604, such as a monitor; a network interface 608, such as a Local Area Network (LAN), a wireless 802.11x LAN, a 3G or 4G mobile WAN or a WiMax WAN; and a computer-readable medium 610. Each of these components may be operatively coupled to a bus 612. For example, the bus 612 may be an EISA, a PCI, a USB, a FireWire, a NuBus, or a PDS.

The computer readable medium 610 may be any suitable medium that participates in providing instructions to the processor 602 for execution. For example, the computer readable medium 610 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 610 may also store other applications, including word processors, browsers, email, instant messaging, media players, and telephony applications.

The computer-readable medium 610 may also store an operating system 614, such as MAC OS, MS WINDOWS, UNIX, or LINUX; network applications 616; and a data structure managing application 618. The operating system 614 may be multi-user, multiprocessing, multitasking, multithreading, real-time and the like. The operating system 614 may also perform basic tasks such as recognizing input from input devices, such as a keyboard or a keypad; sending output to the display 604 and a design tool; keeping track of files and directories on medium 610; controlling peripheral devices, such as disk drives, printers, image capture device; and managing traffic on the bus 612. The network applications 616 include various components for establishing and maintaining network connections for implementing communication protocols including TCP/IP, HTTP, Ethernet, USB, and FireWire.

The data structure managing application 618 provides various components for building/updating an architecture, such as architecture 600, for a non-volatile memory, as described above. In certain examples, some or all of the processes performed by the application 618 may be integrated into the operating system 614. In certain examples, the processes may be at least partially implemented in digital electronic circuitry, in computer hardware, firmware, machine readable instructions or in any combination thereof.

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described, with reference to examples, those skilled in the art are able to make various modifications to the described examples without departing from the scope of the examples as described in the following claims, and their equivalents.

What is claimed is:

1. A three dimensional (3D) video and graphics processing system comprising:
at least one interface to
receive an input video stream, wherein the input video stream comprises a two dimensional (2D) content stream, a 3D content stream, or a 2D and 3D (2D/3D) mixed content stream;
a decoder to decode the input video stream; and
a processor to
determine a source format of the input video stream from the decoded input video stream;
determine a target format for an external device to use to display content; and
determine whether the source format matches the target format;
if the source format matches the target format, send the input video stream to the at least one interface;
if the source format does not match the target format, modify the input video stream to be in the target format and send the modified input video stream to the at least one interface;
wherein the at least one interface is to transmit the input video stream or the modified input video stream sent from the processor as an output video stream to the external device.

2. The system of claim 1, wherein the processor performs handshake signaling with the external device to determine the target format of the external device.

3. The system of claim 2, wherein the external device is operable to utilize multiple 3D formats to display the output video stream and the processor instructs the external device through the handshake signaling to maintain its format in the target format.

4. The system of claim 1, wherein the external device is to display the output video stream received from the at least one interface without switching between different 3D modes or without switching between a 2D mode and a 3D mode.

5. The system of claim 1, wherein the processor is to determine the source format from supplementary enhancement information (SEI) in the decoded input video stream.

6. The system of claim 1, wherein the processor is provided in a set-top box (STB) connected to the external device via the at least one interface.

7. The system of claim 1, wherein the external device is a passive 3D TV, and for 3D conversion in the 3D TV, the processor is to modify received 2D content to a 3D panel format.

8. The system of claim 7, wherein the at least one interface is to transmit panel format received 3D content without modification to the 3D TV.

9. The system of claim 1, wherein the display is a passive 3D TV, and for no 3D conversion in the 3D TV, the processor is to modify received 3D panel format content to a line interleave format.

10. The system of claim 9, wherein the at least one interface is to transmit received 2D content without modification to the 3D TV.

11. The system of claim 1, wherein the display is an active DLP 3D TV and the at least one interface is to transmit received CB 3D content and 2D content without modification to the 3D TV.

12. The system of claim 1, wherein the display is an active DLP 3D TV, the processor is to modify received 3D panel format or full resolution content to CB format, and the at least one interface is to transmit received 2D content without modification to the 3D TV.

13. The system of claim 1, wherein the display is an active panel format 3D TV, the processor is to downscale and cascade received full resolution 3D content to panel format, and modify received 2D content to panel format.

14. The system of claim 1, wherein the display is an active panel format 3D TV, the at least one interface is to transmit received 3D panel format content without modification to the 3D TV, and the processor is to modify received 2D content to panel format.

15. The system of claim 1, wherein the display is an active full resolution 3D TV, the at least one interface is to transmit received full resolution 3D content without modification to the 3D TV, and the processor is to repeat received 2D content.

16. The system of claim 1, wherein the display is an active full resolution 3D TV, the processor is to upscale received 3D panel format content to full resolution 3D format, and repeat received 2D content.

17. The system of claim 1, wherein the processor is to generate graphics based on the target format and overlay the graphics on the output video stream to be transmitted to the external device from the at least one interface.

18. The system of claim 17, wherein the processor is to determine an external device mapping, wherein the external device mapping comprises a mapping of pixels from the target format to a display format of the external device; and
the processor is to overlay the graphics on the output video stream by mapping lines from the graphics to a panel in the target format according to the external device mapping.

19. A method for three dimensional (3D) video and graphics processing comprising:
receiving an input video stream, wherein the input video stream comprises a two dimensional (2D) content stream, a 3D content stream, or a 2D and 3D (2D/3D) mixed content stream;
decoding the input video stream;
determining a source format of the input video stream from the decoded input video stream;
determining a target format for an external device to use to display content; and
determining, by a processor, whether the source format matches the target format;
if the source format matches the target format, sending the input video stream to at least one interface;
if the source format does not match the target format, modifying the input video stream to be in the target format and sending the modified input video stream to the at least one interface;
wherein the at least one interface is to transmit the input video stream or the modified input video stream as an output video stream to the external device.

20. The method of claim 19, further comprising performing handshake signaling with the external device to determine the target format of the external device.

21. The method of claim 20, wherein the external device is operable to utilize multiple 3D formats to display the output video stream, the method further comprises instructing the external device through the handshake signaling to maintain its format in the target format.

22. The method of claim 19, further comprising displaying at the external device the output video stream received from the at least one interface without switching between different 3D modes or without switching between a 2D mode and a 3D mode.

23. The method of claim 19, further comprising determining the source format from supplementary enhancement information (SEI) in the decoded input video stream.

24. The method of claim 19, further comprising providing the processor in a set-top box (STB) connected to the external device via the at least one interface.

25. The method of claim 19, wherein the external device is a passive 3D TV, and for 3D conversion in the 3D TV, the method further comprises modifying received 2D content to a 3D panel format.

26. The method of claim 25, further comprising transmitting panel format received 3D content without modification to the 3D TV.

27. The method of claim 19, wherein the display is a passive 3D TV, and for no 3D conversion in the 3D TV, the method further comprises modifying received 3D panel format content to a line interleave format.

28. The method of claim 27, further comprising transmitting received 2D content without modification to the 3D TV.

29. The method of claim 19, wherein the display is an active DLP 3D TV and the method further comprises transmitting received CB 3D content and 2D content without modification to the 3D TV.

30. The method of claim 19, wherein the display is an active DLP 3D TV, the method further comprises modifying received 3D panel format or full resolution content to CB format, and transmitting received 2D content without modification to the 3D TV.

31. The method of claim 19, wherein the display is an active panel format 3D TV, the method further comprises downscaling and cascading received full resolution 3D content to panel format, and modifying received 2D content to panel format.

32. The method of claim 19, wherein the display is an active panel format 3D TV, the method further comprises transmitting received 3D panel format content without modification to the 3D TV, and modifying received 2D content to panel format.

33. The method of claim 19, wherein the display is an active full resolution 3D TV, the method further comprises transmitting received full resolution 3D content without modification to the 3D TV, and repeating received 2D content.

34. The method of claim 19, wherein the display is an active full resolution 3D TV, the method further comprises upscaling received 3D panel format content to full resolution 3D format, and repeating received 2D content.

35. The method of claim 19, further comprising generating graphics based on the target format and overlaying the graphics on the output video stream to be transmitted to the external device from the at least one interface.

36. The method of claim 35, further comprising:
determining an external device mapping, wherein the external device mapping comprises a mapping of pixels from the target format to a display format of the external device; and
overlaying the graphics on the output video stream by mapping lines from the graphics to a panel in the target format according to the external device mapping.

37. A non-transitory computer readable medium storing computer readable instructions that when executed by a computer system perform a method for three dimensional (3D) video and graphics processing, the method comprising:
receiving an input video stream, wherein the input video stream comprises a two dimensional (2D) content stream, a 3D content stream, or a 2D and 3D (2D/3D) mixed content stream;
decoding the input video stream;
determining a source format of the input video stream from the decoded input video stream;
determining a target format for an external device to use to display content; and
determining, by a processor, whether the source format matches the target format;
if the source format matches the target format, sending the input video stream to at least one interface;
if the source format does not match the target format, modifying the input video stream to be in the target format and sending the modified input video stream to the at least one interface;
wherein the at least one interface is to transmit the input video stream or the modified input video stream as an output video stream to the external device.
